(19) United States
(12) Patent Application Publication
(10) Pub. No.: US 2002/0052981 A1
(43) Pub. Date: May 2, 2002

(54) Method for suppressing a menu, method for controlling copying and moving of data and computer-readable recording medium recorded with program code for controlling a menu

(75) Inventor: Hisao Yasuda, Hino (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/940,662

(22) Filed: Aug. 29, 2001

(30) Foreign Application Priority Data
Aug. 31, 2000 (JP) 2000-262971

(51) Int. Cl. G06F 9/46; G06F 9/00; G06F 1/24

(52) U.S. Cl. 709/320; 713/100

(57) ABSTRACT

In a method for suppressing menu items on a menu, the menu items are retrieved for the menu when an operating system conducts a hook function to notify that an application displays the menu. A suppress process, which is indicated in a definition file for each of the menu items, is conducted when the menu items have been registered in the definition file and the menu having the menu items is passed to the application when the suppress process is conducted in the step. Then, the menu is displayed with the menu items for each of which the suppress process is conducted.

### BACKGROUND OF THE INVENTION

1. Field of the Invention

The present invention generally relates to methods for suppressing a menu, methods for controlling copying and moving of data and computer-readable recording media recorded with program code for controlling a menu.

2. Description of the Related Art

Conventionally, in a computer such as a personal computer, an application activated on an OS (Operating System) displays several menus and the application executes a predetermined function (for example, copy or a like) selected by a user from a menu. Also, the application provides a function for moving data by dragging by a mouse.

In a case in which an application, which developed by a manufacture itself, conducts a transaction based on data processed by using another application developed by another manufacture, and the application is exhibited for users, generally, all functions provided in the application are available for the users. Thus, there are problems as follows:

(1) a system error could be occurred by an unexpected operation of users.

(2) a system destruction could be occurred by a malicious user replacing a system file.

(3) a file replacement could be occurred by a malicious user remotely operating a file at an internet cafe.

(4) a secret leak could be occurred by copying electronic information.

### SUMMARY OF THE INVENTION

It is a general object of the present invention to provide methods for suppressing a menu, methods for controlling copying and moving of data and computer-readable recording media recorded with program code for controlling a menu in which the above-mentioned problems are eliminated.

A more specific object of the present invention is to provide a method for suppressing a menu, a method for controlling copying and moving of data and a computer-readable recording medium recorded with program code for controlling a menu, in which an application ID, which corresponds to a menu item of an application by an operation of a user, is extracted by a hook function of an OS (Operation System) and a definition file is referred and the menu item is suppressed to display, so that an incorrect operation, an information leak, a falsification and a system destruction can be prevented, instead of modifying the application and the OS.

The above objects of the present invention are achieved by a method for suppressing menu items on a menu, including the steps of: (a) retrieving the menu items for the menu when an operating system conducts a hook function to notify that an application displays the menu; (b) conducting a suppress process indicated in a definition file for each of the menu items when the menu items retrieved in the step (a) have been registered in the definition file; and (c) passing the menu having the menu items to the application when the suppress process is conducted in the step (b), whereby the menu is displayed with the menu items for each of which the suppress process is conducted.

According to the present invention, it can be realized that an error operation to the menu items by the user, the information leak, the falsification, or the system destruction is protected, instead of modifying the application or the OS.

The above objects of the present invention are achieved by a method for controlling a dialog box, including the steps of: (a) detecting a notice for displaying the dialog box and dialog items when an operating system conducts a hook function to notify that an application displays the dialog box; (b) conducting a suppress process indicated in a definition file for the dialog box when the notice for displaying the dialog box detected in the step (a) has been registered; and (c) passing the menu having the menu items to the application when the suppress process is conducted in the step (b), whereby the dialog box is displayed in which the suppress process is conducted for the dialog items.

According to the present invention, a save button in a save dialog box can be controlled to become invisible and also the save dialog box is disabled to save data. Therefore, it can be realized to prohibit the user saving data, instead of modifying the application or the OS.

The above objects of the present invention are achieved by a method for controlling copying of data, including the steps of: (a) detecting a notice for copying data when an operating system conducts a hook function to notify that a copy operation is conducted on an application; (b) clearing a content of a clipboard when the notice for copying data is detected in the step (a) has been registered in a definition file and a copy suppress is indicated in the definition file; and (c) passing the clipboard to the application when the content of the clipboard is cleared in the step (b), whereby the application copies the content of the clipboard which is empty.

According to the present invention, the content in the clipboard is cleared when the user copies data on the application. Therefore, it can be realized to the user copying data without notice, instead of modifying the application or the OS.

The above objects of the present invention are achieved by a method for controlling moving of data, including the steps of: (a) detecting a notice for moving data when an operating system conducts a hook function to notify that a move operation indicating a move-to location and a move-from location is conducted on an application; (b) changing the move-to location to the move-from location when the notice for moving data is detected in the step (a) has been registered in a definition file and a move suppress is indicated in the definition file; and (c) passing the move-to location to the application when the move-to location is changed in the step (b), whereby the application moves the data from the move-from location to the move-to location which is the move-to location.

According to the present invention, the move-to to the move-from is compulsory changed when the user moves data from the move-from to the move-to when the user moves data on the application. Therefore, it can be realized to the user moving data, instead of modifying the application or the OS.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a functional configuration of a computer system according to an embodiment of the present invention;

FIG. 2 is a flowchart diagram showing a define operation by a user to create a definition file (definition file creation) according to the embodiment of the present invention;

FIG. 3 is a diagram showing the window example to create the definition file (definition file creation);

FIG. 4 is a flowchart diagram for explaining the hook function according to the embodiment of the present invention;

FIG. 5 is a flowchart diagram for explaining operations in a case in which a menu is displayed (menu display), according to the embodiment of the present invention;

FIG. 6A is a diagram showing one example of menu items suppressed to display (suppression), according to the embodiment of the present invention and

FIG. 6B is a diagram showing another example of menu items suppressed to display (suppression), according to the embodiment of the present invention;

FIG. 7A is a diagram showing operations of the user, a hook function of OS, and operations (input) of an application and

FIG. 7B is a flowchart diagram for explaining a typical process example executed when a menu initialization is conducted by a basic hook (hook FB);

FIG. 8 is a flowchart diagram for explaining a setting for suppressing a copy operation by the user, according to the embodiment of the present invention;

FIG. 9 is a flowchart diagram for explaining an operation for suppressing copying of data according to the embodiment of the present invention;

FIG. 10 is a flowchart diagram for explaining a setting for suppressing a move operation by the user, according to the embodiment of the present invention;

FIG. 11 is a flowchart diagram for explaining an operation for suppressing moving of data according to the embodiment of the present invention;

FIG. 12 is a flowchart diagram for explaining a setting for suppressing a save operation by the user, according to the embodiment of the present invention;

FIG. 13 is a flowchart diagram for explaining an operation for suppressing saving of data according to the embodiment of the present invention;

FIG. 14 is a front view of a computer system according to the embodiment of the present invention;

FIG. 15 is a diagram showing a hardware configuration of the computer system according to the embodiment of the present invention; and

FIG. 16 is a diagram showing a network system in which the tool is installed, according to the present invention.

### DESCRIPTION OF THE PREFERRED EMBODIMENTS

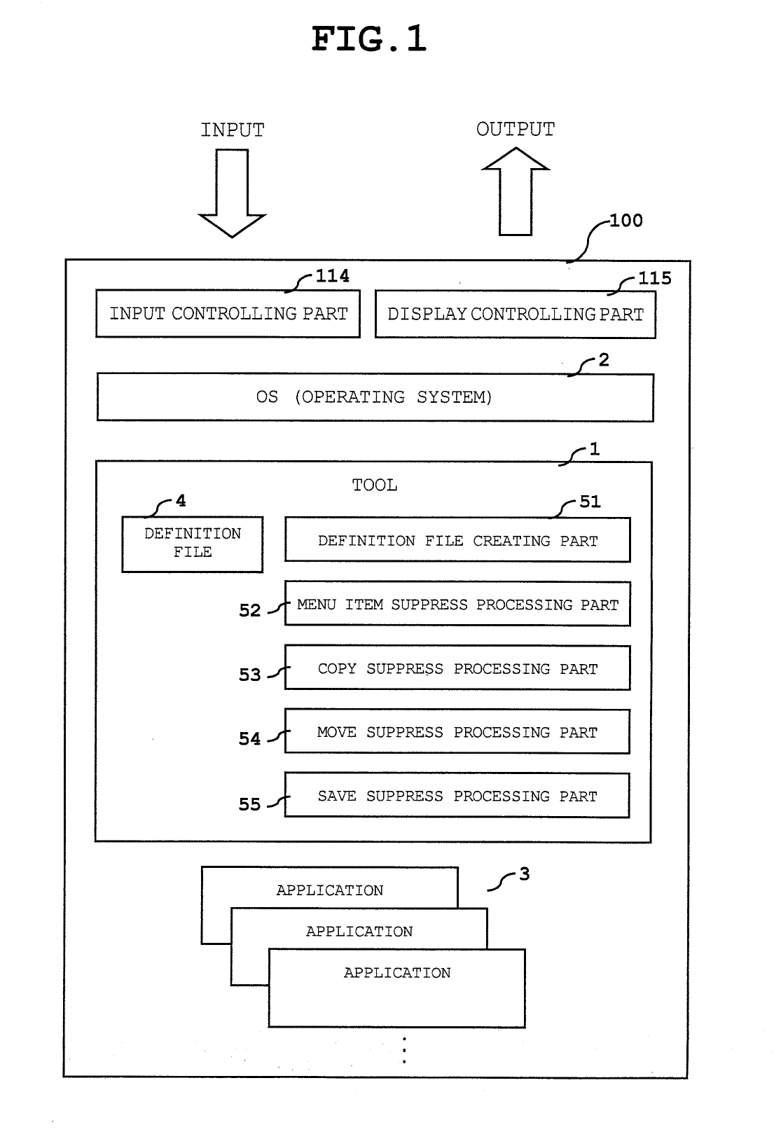

A functional configuration of a computer system solving the above problems will now be described with reference to FIG. 1. FIG. 1 is a diagram showing the functional configuration of the computer system according to an embodiment of the present invention.

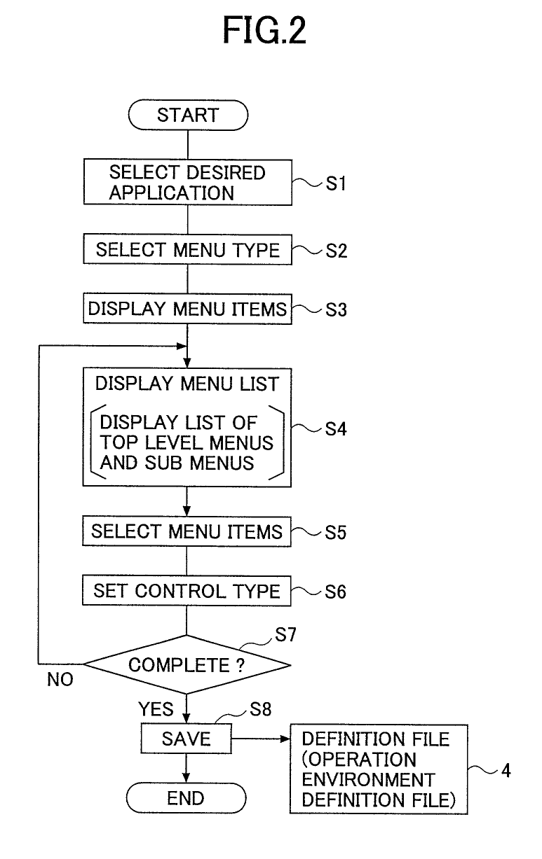

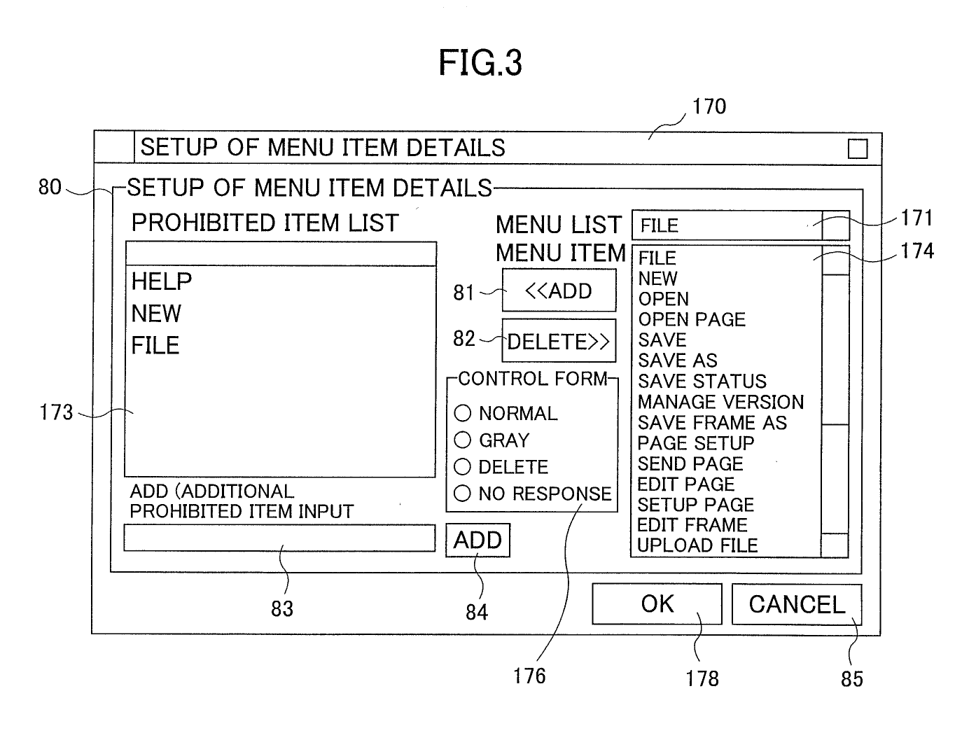

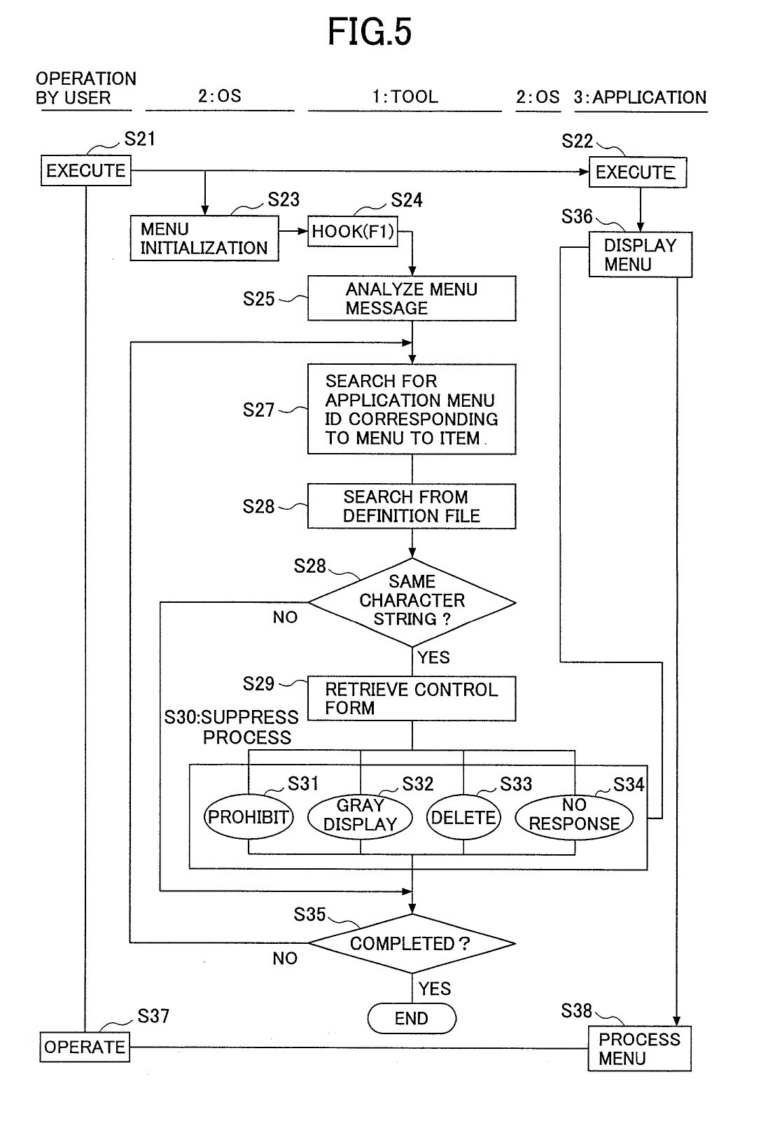

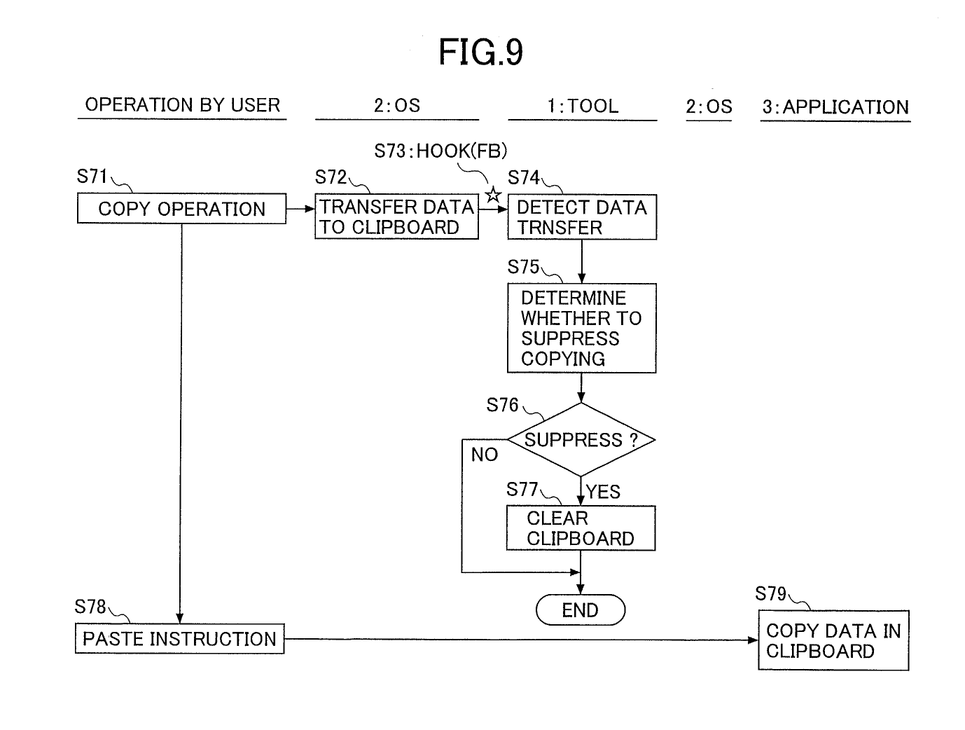

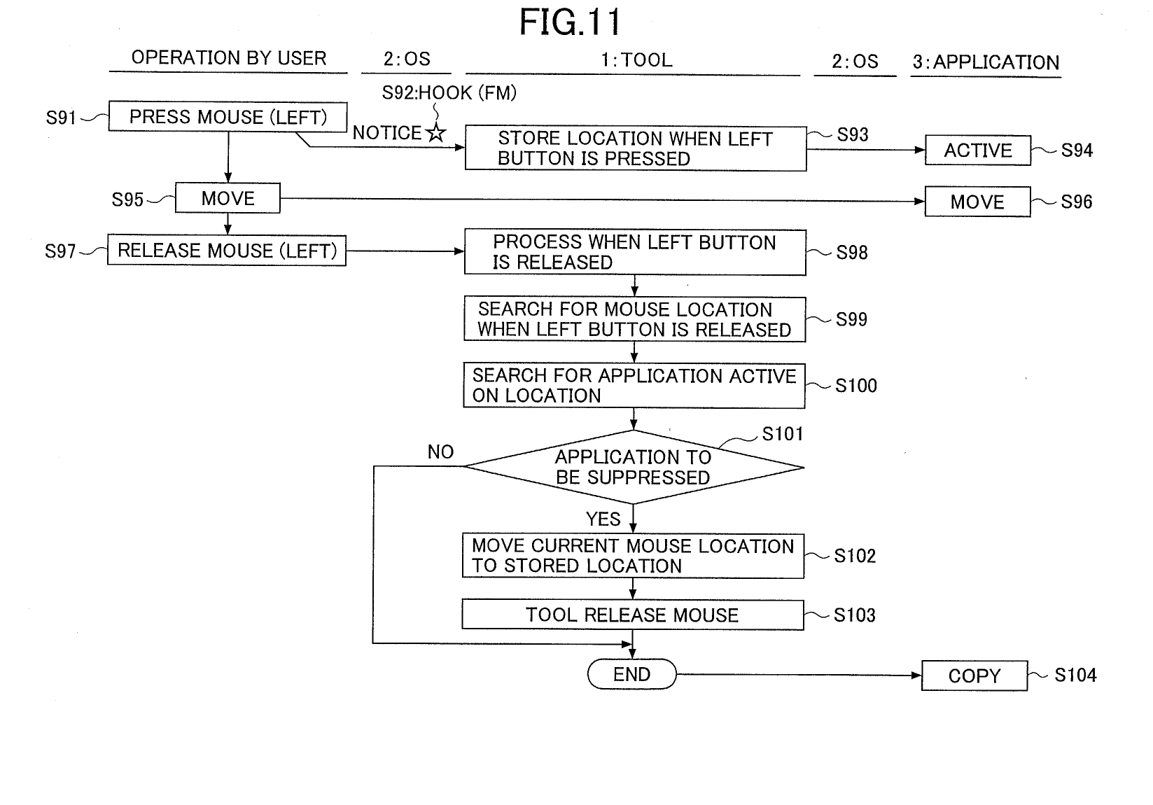

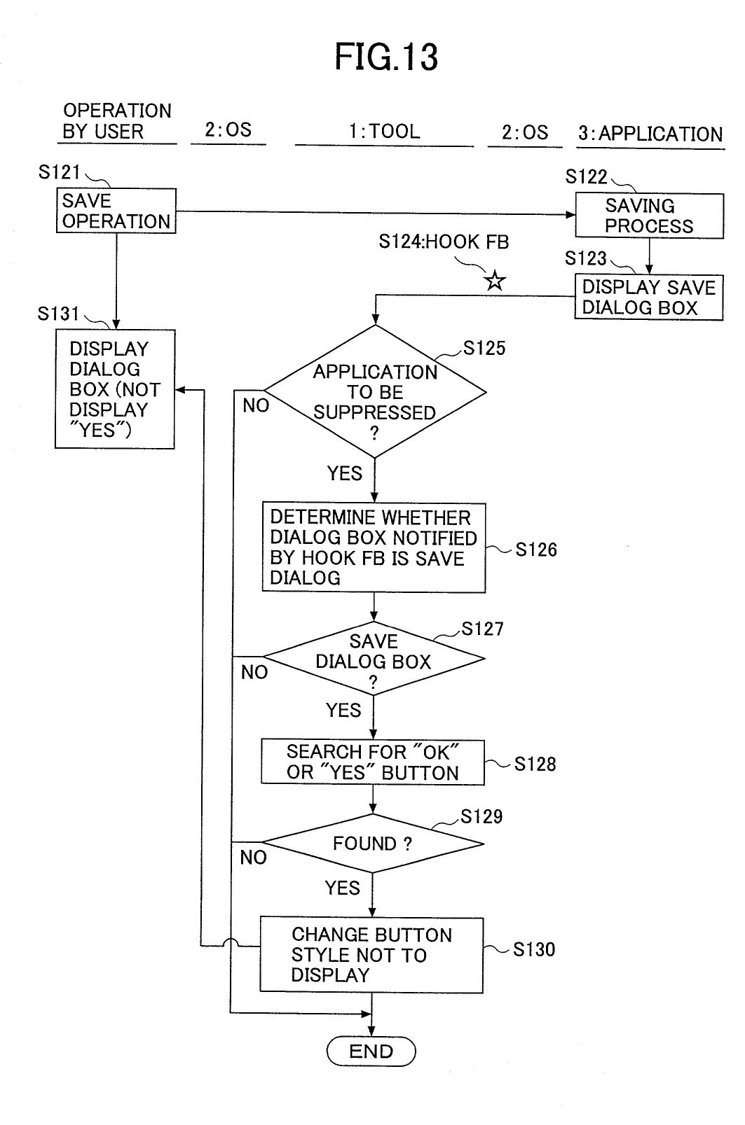

In FIG. 1, the computer system 100 as a user terminal includes a tool 1, an OS (Operating System) 2, and at least one application 3. The tool 1 is a resident program between the OS 2 and the application 3, and controls to suppress a menu display, a dialog box display, a copy operation, a move operation, or the like (described later). The tool 1 further includes a definition file 4, a definition file creating part 51 (described in FIG. 2 and FIG. 3), a menu item suppress processing part 52 (described in FIG. 5), a copy suppress processing part 53 (described in FIG. 9), a move suppress processing part 54 (described in FIG. 11), and a save suppress processing part 55 (described in FIG. 13).

The OS 2 is an operating system and conducts several controls (described later).

The application 3 is an application program. In this embodiment, it is assumed that the application 3 conducts several transactions by a menu display, a dialog box display, a copy operation, a move operation and the like.

An operation of the tool 1 will now be described.

The tool 1 retrieves menu items to display for a menu when the OS 2 conducts a hook function to notify of the tool 1 that an instruction of displaying a menu for the application 3 is conducted. When the retrieve menu items are defined beforehand in a definition file 4 and a control form, which is a suppress method, is registered for the retrieved menu, the tool 1 sends the retrieved menu to the application 3 after conducting a suppress process for the retrieved menu based on the control form.

In addition, when the OS 2 conducts the hook function to notify of the tool 1 that an instruction of displaying a menu for the application 3 is conducted, the tool 1 retrieves the menu items for the menu and also an application ID of the menu items. When the control form for the retrieve menu items is registered in the definition file 4 in which a plurality of menu items are defined beforehand, tool 1 conducts the suppress process registered for a location of the retrieved application ID corresponding to the menu items. Then, the tool 1 sends the menu including the menu items that the suppress process is conducted for, to the application 3 to display.

Also, when a dialog box display is instructed and then the OS 2 conducts the hook function to notify an instruction of the tool 1, the tool 1 detects the instruction of displaying the dialog box and dialog items. When the tool 1 detects the instruction of displaying the dialog box and a control form for the detected dialog items is registered in the definition file in which a plurality of dialog items are defined beforehand, the tool 1 conducts the suppress process for the retrieved dialog items based on the control form. Then, the tool 1 sends the dialog box which the suppress process is conducted for, to the application 3 to display.

In the suppress process, the tool 1 conducts at least one of an operation suppress and an operation prohibition mark display for an item, the operation suppress and a brightness or color suppress display for the item, or the operation suppress and operation suppress for the item.

Also, when a data copy is instructed and then the OS 2 conducts the hook function to notify an instruction of the tool 1, the tool 1 detects the instruction of a copy operation by the user. When the tool 1 detects the copy operation and a copy suppress is registered in the definition file, the tool 1 clears a content in a clipboard and then sends the cleared clipboard to the application 3. The application 3 copies the content (actually no data) in the clipboard.

Also, when a data move indicating a data move-from and a data move-to is instructed and then the OS 2 conducts the hook function to notify an instruction of the tool 1, the tool 1 detects the instruction of a move operation by the user. When the tool 1 detects a move operation and a move suppress is registered in the definition file, the tool 1 changes the move-to to the move-from and then sends the changed move-to to the application 3. The application 3 moves data to the changed move-to.

Also, when the data move-to is indicated and the OS 2 conducts the hook function to notify and instruction of the tool 1, the tool 1 detects an instruction of a move-to operation by the user. When the move-to operation is detected and the move suppress is registered in the definition file, the tool 1 changes the move-to to the move-from and sends the changed move-to to the application 3 so that the application 3 moves data to the move-to that is actually original location (move-from).

Accordingly, in response to an operation of user, the OS 2 conducts the hook function and then the tool 1 retrieves the application ID corresponding to a menu item of the application 3, refers to the definition file, and processes to suppress a function corresponding to the menu item. Therefore, it can be realized that an error operation by the user, a information leak, a falsification, or a system destruction is protected, instead of modifying the application 3 or the OS 2.

Next, details of functional operations will now be described with reference to FIG. 2 through FIG. 13.

FIG. 2 is a flowchart diagram showing a define operation by a user to create a definition file (definition file creation) according to the embodiment of the present invention. In FIG. 2, the user is a system manager who has a responsibility of preventing the incorrect operation by ordinary users, the information leak, the falsification, and the system destruction, and the system manager sets up each user terminal in accordance with the flowchart shown in FIG. 2. In FIG. 2, it is shown that the define operation by the system manager define a control form for each of menu items (top level items and sub level items) on the menu and then the definition file (an operation environment definition file) 4 is created.

In step S1 of FIG. 2, the system manager executes the tool 1 to create the definition file 4 for a desired application. The tool 1 executes the definition file creating part 51 and then the definition file creating part 51 displays a define window at a display unit of the user terminal. Then, the system manager selects the desired application. That is, the system manager selects one application 3 (application program, software, or a like) necessary to suppress menu items on a menu.

In step S2, the system manager selects a menu type. That is, the system manager selects one menu type that is used in the application 3 selected in step S1.

In step S3, the definition file creating part 51 of the tool 1 displays menu items.

In step S4, the definition file creating part 51 displays a menu list. That is, as shown in FIG. 3 that will be described later, by step S3 and step S4, a list (top level menus and sub menus) of entire menus for the menu type selected in step S2 of the application 3 selected in step S1 are displayed. In a window example shown in FIG. 3, a menu item on a top level menu is listed at a top row and then sub menu items are listed for each sub menu in following rows.

In step S5, the system manager selects desired menu items. That is, for example, the system manager selects one or more desired menu items, which are to be suppressed, from the menu list that is displayed at a right side in the window example of FIG. 3 in step S4.

In step S6, the system manager sets a control form for the desired menu items selected in step S5. That is, the system manager indicates one of control forms as shown in a control form field in FIG. 3:

normal (display with a prohibition mark, disable operation)

gray (display in gray, disable operation)

delete (delete not to display, disable operation)

no response (display, but disable operation).

In this case, displaying in gray can be to display in darker luminosity than a normal display or in a darker color.

In step S7, the system manager determines whether or not the system manager completes to indicate control forms for all desired menus. When the system manager determines that the system manager completes to indicate control forms for all desired menus (YES), the system manager clicks OK button to save a new definition file (operation environment definition file) 4 (step S8) and then completes all operations to create the new definition file 4 (END). On the other hand, when the system manager determines that the system manager has not completed yet to indicate control forms for all desired menus (NO), the system manager goes back to step S4 and repeats the above steps.

As described above, it is possible for the system manager to select menu items necessary to suppress, from the menu item list for all menu items on the menus that are used by the application 3, and to indicate a control form for the menu items selected, and then to save the control form by relating to the menu items to the definition file (operation environmental definition file) 4.

FIG. 3 is a diagram showing the window example to create the definition file 4 (definition file creation). Only the system manager is allowed to create the definition file 4.

In a window 170 for setting menu item details as the window example shown in FIG. 3, right side field includes pull-down menus, and automatically retrieve and display the menu list for all menu items on the menus used by the application 3 that are selected by the system manager.

A left side field shows menu items (character strings) that are selected from the menu list shown in the right side fields to suppress. For example, three menu items of “HELP”, “NEW” and “FILE” are registered. It is not shown in FIG. 3, but the control form is registered for each or the entire of these menu items (character strings) selected by the system manager.

The control form field shown in a center field of the window 170 is for indicating and registering the control form of the menu item selected from the menu list shown in the right side fields.

As describe above, the menu item list of all the menu items on the menu of the application 3 is displayed, so that the system manager can select menu items from the menu item list and indicate the control form to register (as a prohibited item list in FIG. 3). Then, the definition file 4 is created.

In detail, the window 170 is opened at the display unit of the user terminal after the user selects the application 3 in the step S1 in FIG. 2. In the window 170, the system manager selects one menu type to a menu list 171 on the right side field in the step S2 in FIG. 2. A menu item 174 shows potential menu items related to the menu type selected from the menu list 171. The potential menu items are registered beforehand.

When the system manager selects one of the potential menu items and clicks an add button 81 by a mouse, a selected potential menu item is moved to and additionally shown in a prohibited item list 173 shown in the left side field. When the system manager selects one item from the prohibited item list 173 and clicks a delete button 82 by a mouse, a selected item goes back to the menu item 174.

When the system manager completes to select items to prohibit, the system manager selects one control form in a control form 176 shown in the center field and then clicks an OK button 178 to save or a cancel button 85 not to save.

In addition, the system manager can add a menu item, which is not listed in the menu item 174, by inputting in an additional item 83 and clicking an add button 84.

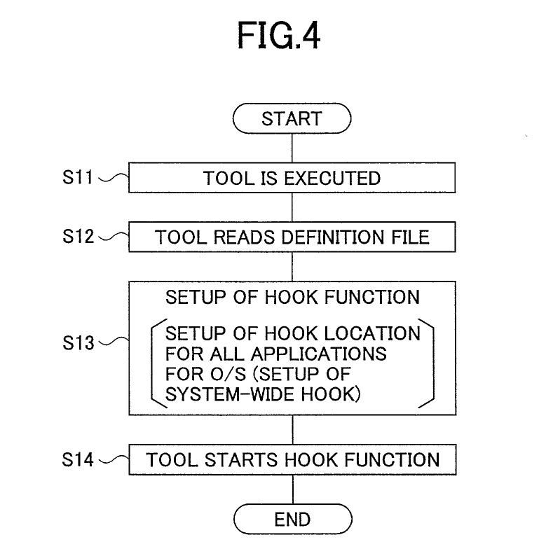

FIG. 4 is a flowchart diagram for explaining the hook function according to the embodiment of the present invention.

In step S11 of FIG. 4, the tool 1 is automatically executed by the OS 2 when the OS 2 is activated. That is, a program acting as the tool 1 shown in FIG. 5 is executed and resides in a memory unit of the computer system 100.

In step S12, the tool 1 reads the definition file (environmental definition file) 4. That is, the tool 1 reads the definition file 4 to which the system manager selects the menu items from the window 170 as shown in FIG. 3, indicates and registers the control form in accordance with the flowchart described in FIG. 2.

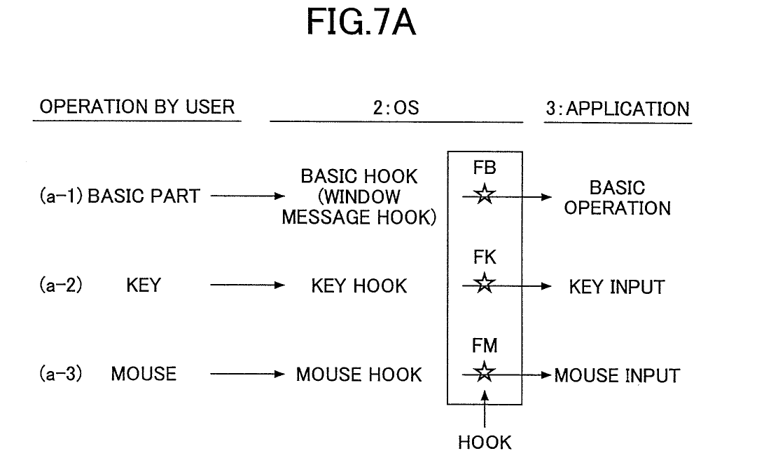

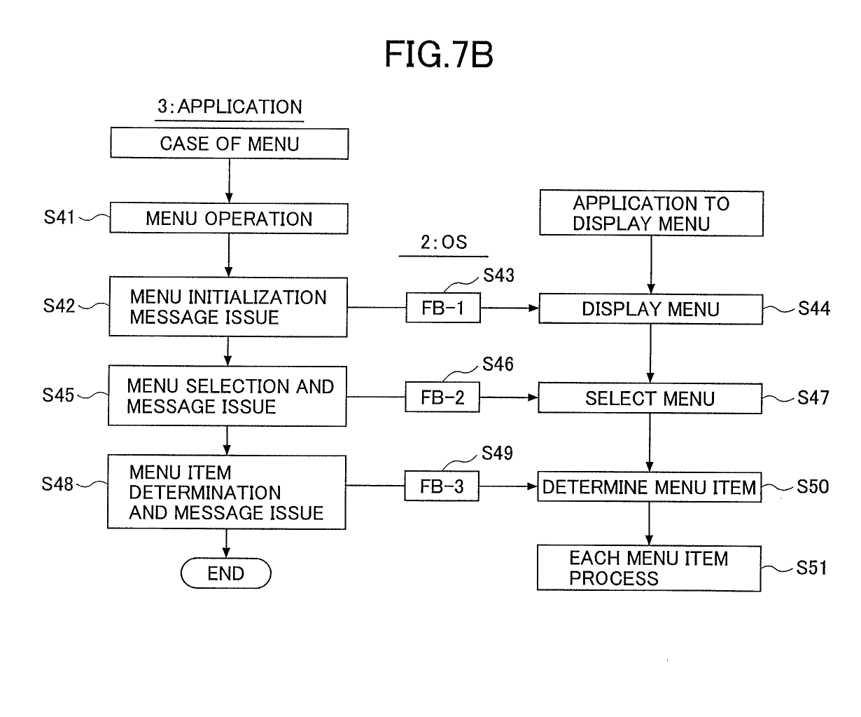

In step S13, the tool 1 sets up the hook function. That is, for example, the tool 1 sets up a hook location for all applications 3 for the OS 2 (setup of system-wide hook)(described later with reference to FIG. 7).

In step S14, the tool 1 starts the hook function.

As described above, it is possible for the tool 1 to reside, read the definition file 4, and start the hook function (notifying of the tool 1 by the hook location) for all applications 3.

FIG. 5 is a flowchart diagram for explaining operations in a case in which a menu is displayed (menu display), according to the embodiment of the present invention. In FIG. 5, the operations, in a case in which the system manager selects the menu item on the menu displayed at a system manager terminal and a process corresponding to the menu item is conducted, is explained.

The OS 2 is an operating system and conducts several controls. In this embodiment, the OS 2 includes the hook function and notifies of the tool 1 via the hook location, and the tool 1 sends the menu to the application 3 after the tool 1 conducts several suppress processes for the menu items on the menu.

When the tool 1 is notified of from the OS 2 via the hook location, the tool 1 conducts the suppress process (corresponding to the control form set by the system manager) for the menu items on the menu, and then sends to the application 3.

Each application 3 conducts various processes based on the menu and the menu item selected by the system manager.

In step S21 in FIG. 5, a user instructs to execute the application 3.

In step S22, the application 3 is executed in accordance with the execution instruction conducted by the user in step S21. As described in FIG. 4, the tool 1 resides and has already read the definition file 4.

In step S23, the OS 2 conducts a menu initialization.

In step S24, the OS 2 conducts a hook (F1) when the menu is initialized, and the tool 1 takes over to control from the OS 2.

In step S25, when the tool 1 is notified via the hook location by the hook (F1) conducted by the OS 2, the tool 1 executes the menu item suppress processing part 52 and the menu item suppress processing part 52 analyzes a menu message.

In step S26, the menu item suppress processing part 52 searches for an application menu ID corresponding to a menu item. That is, when the tool 1 is notified in the step S25, the menu item suppress processing part 52 executed by the tool 1 searches for the application menu ID for the menu corresponding to all menu items on the menu (the menu initialized in the step S23). The menu item suppress processing part 52 searches for the application menu ID on the menu of the application 3 for the menu item (for example, a character string “NEW” shown in the left side field in FIG. 3), and then stores the application menu ID by relating to the menu item. Thus, it is possible to determine a location of the menu item on the menu since the application menu ID uniquely specifies the location of the menu item. By relating the menu item (character string) in one definition file 4 to the location of the menu item on the menu of the application 3, advantageously, it is possible to suppress the menu item at the location related in the definition file 4.

In step S27, the menu item suppress processing part 52 searches for a character string showing the menu item from the definition file 4. That is, the menu item suppress processing part 52 determines whether or not each menu item on the menu searched in the steps S25 and S26 is registered so as to suppress.

In step S28, it is determined whether or not the same character string is found in the definition file 4. When the same character string is found (YES), it is determined that the same character string showing the menu item retrieved from the menu is registered in the definition file 4, and then the menu item suppress processing part 52 advances to step S29. On the other hand, when the same character string is not found (NO), it is determined that the same character string showing the menu item retrieved from the menu and it is determined that the suppress control is not conducted. Thus, the menu item suppress processing part 52 advances to step S35.

In step S29, the control form is retrieved from the definition file 4 since it is determined as “YES” in the step S28 that the suppress control is to be conducted.

In step S30, the suppress process is conducted. That is, the menu item suppress processing part 52 conducts one of the suppress processes in step S31 through S34, which corresponds to the control form retrieved in step S29, for the menu item on the menu.

In step S31, since it is determined that the control form retrieved in the step S29 indicates to prohibit the menu item, the menu item suppress processing part 52 additionally provides a prohibition mark to the menu item on the menu and also sets the operation disable to the menu item. Accordingly, an operation for the menu is disabled even if the user selects the menu item. Then, the menu item suppress processing part 52 advances to step S35.

In step S32, since it is determined that the control form retrieved in the step S29 indicates to display the menu item in gray, the menu item suppress processing part 52 sets the menu item on the menu to be displayed in gray and also sets the operation disable to the menu item. Accordingly, the operation for the menu is disabled even if the user selects the menu item. Then, the menu item suppress processing part 52 advances to the step S35.

In step S33, since it is determined that the control form retrieved in the step S29 indicates to delete the menu item, the menu item suppress processing part 52 deletes the menu item on the menu not to display and also sets the operation disable to the menu item. Accordingly, the operation for the menu is disabled even if the user selects a location of the menu item that is deleted. Then, the menu item suppress processing part 52 advances to the step S35.

In step S34, since it is determined that the control form retrieved in the step S29 indicates not to respond, the menu item suppress processing part 52 remains to display the menu item on the menu and also sets no response (operation disable) to the menu item. Accordingly, the operation for the menu is disabled even if the user selects the menu item. Then, the menu item suppress processing part 52 advances to the step S35.

In step S35, the menu item suppress processing part 52 determines whether or not the menu item suppress processing part 52 completes the above steps for all same character strings. When the menu item suppress processing part 52 completes the above steps for all same character strings (YES), the menu item suppress processing part 52 terminates the operation for suppressing the menu ites. When the menu item suppress processing part 52 has not completed yet (NO), the menu item suppress processing part 52 goes back to the step S26 and repeats the above steps for a next menu item on the menu.

In step S36, the application 3 displays the menu. That is, the application 3 displays the menu based on all menu items on the menu that the menu item suppress processing part 52 conducts the suppress process to or not in the step S30.

In step S37, the user operates the menu displayed in the step S36.

In step S38, the application 3 conducts a menu process in response to an operation (a selection) of the user to the menu item on the menu. In detail, when the user operates the menu item which the suppress process is conducted for in the step S30, the application 3 conducts a given operation (operation disable or no response) set by the menu item suppress processing part 52 in the steps S31 through S34. On the other hand, when the step S30 is skipped and the suppress process is not conducted for the menu items, the menu process corresponding to the menu item selected by the user is conducted.

As described above, the application 3 is executed in a state in which the tool 1 resides and read the definition file 4 beforehand and the hook function is set. When the OS 2 conducts the hook function to automatically notify of the tool 1 via the hook location, the menu item suppress processing part 52 executed by the tool 1 conducts the suppress process for the menu items based on the definition file 4 in accordance with the steps S25 through S35 and then the menu having the menu items for which the suppress process is conducted is sent to the application 3. Thus, it is possible to suppress various operations conducted by the user in accordance with the menu for which menu items the suppress process is conducted. The menu items on the menu can be automatically modified to prohibit (operation disable), display in gray (operation disable), delete (operation disable), or not to respond (operation disable). Accordingly, it can be realized to prevent the incorrect operation by the user, the information leak, the falsification, and the system destruction, instead of modifying the application 3 or the OS 2.

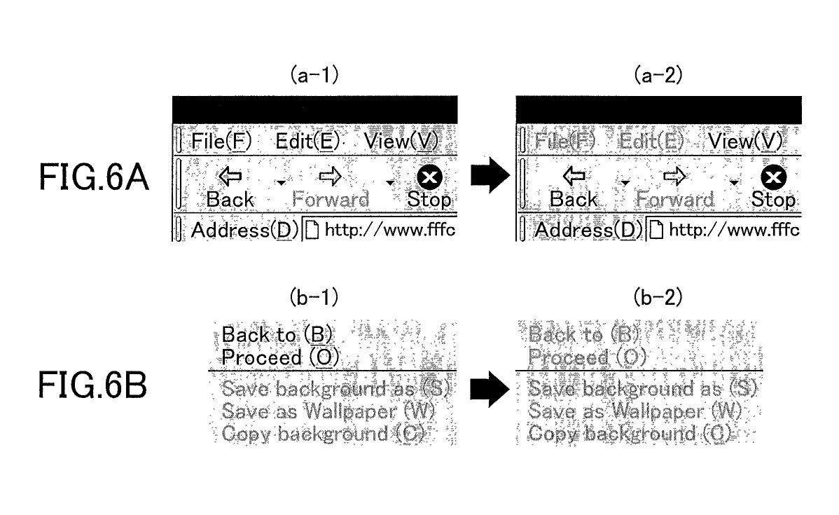

FIG. 6A and FIG. 6B are diagrams showing examples of menu items suppressed to display (suppression), according to the embodiment of the present invention. In FIG. 6A and FIG. 6B, two cases in which the suppress process is conducted for the menu items on the menu are illustrated.

A menu indicated by (a-1) in FIG. 6A illustrates an example in which a menu item “Forward” is displayed in gray (operation disable) (step S32 in FIG. 5).

Another menu indicated by (a-2) in FIG. 6A illustrates a further example in which other menu items “File” and “Edit” in the menu indicated by (a-1) are displayed in gray (operation disable).

As shown in the menus indicated by (a-1) and (a-2) in FIG. 6A, by registering the menu items “Forward”, “File”, “Edit”, and a like and registering the control form for the menu items, the menu item suppress processing part 52 automatically conducts the suppress process (S30) for the menu based on the definition file 4 in accordance with the flowchart shown in FIG. 5. Also, the application 3 conducts various processes based on the menu for which the suppress process is conducted. Therefore, it can be realized to prevent the incorrect operation by the user, the information leak, the falsification, and the system destruction, instead of modifying the application 3 or the OS 2.

A menu indicated by (b-1) in FIG. 6B illustrates an example in which menu items “Save background as”, “Save as wallpaper”, and “Copy background” are displayed in gray (operation disable).

Another menu indicated by (b-2) in FIG. 6B illustrates a further example in which other menu items “Back to” and “Proceed” in the menu indicated by (b-1) are displayed in gray (operation disable).

Such as the examples indicated by (b-1) and (b-2) in FIG. 6B, by registering the menu items on the menu to the definition file 4 and registering the control form, the menu item suppress processing part 52 automatically conducts the suppress process (S30) for the menu based on the definition file 4 in accordance with the flowchart shown in FIG. 5, and then the application 3 conducts various processes based on the menu for which the suppress process is conducted. Therefore, it can be realized to prevent the incorrect operation by the user, the information leak, the falsification, and the system destruction, instead of modifying the application 3 or the OS 2.

The hook function according to the embodiment of the present invention will be explained with reference to FIG. 7A and FIG. 7B.

FIG. 7A is a diagram typically showing operations of the user, the hook function of OS, and operations (input) of the application 3.

A status indicated by (a-1) in FIG. 7A typically illustrates an operation stream of a basic part operated by the hook function. For example, this operation stream is related to a basic operation by the hook function such as a menu initialization. When the user operates the basic part, the OS 2 conducts a basic hook (FB) such as a window message hook at a predetermined location (for example, a hook function after the menu initialization), sends to the application 3 to execute a basic operation (for example, display an initialized menu).

Similarly, other statuses indicated by (a-2) and (a-3) typically illustrates other operation streams. In other status indicated by (a-2) and (a-3), the OS 2 conducts a key hook (FK) or a mouse hook (FM) at a predetermined location when the user operates a key or a mouse and then application 3 starts to control processing a key input or a mouse input.

FIG. 7B is a flowchart diagram for explaining a typical process example executed when the menu initialization is conducted by the basic hook (hook FB).

In step S41 in FIG. 7B, the user operates the menu.

In step S42, a menu initialization message is issued.

In step S43, the OS 2 initializes the menu and conducts a hook FB-1 to notify the menu initialization message of the application 3 (hereinafter called a suppressed application 3) to display the menu.

In step S44, the suppressed application 3 displays the menu.

In step S45, when the user selects a menu, a selection message is issued.

In step S46, the OS 2 conducts a hook FB-2 and notifies the selection message of the suppressed application 3.

In step S47, when notified, the suppressed application 3 selects the menu based on the message issued in the step S45.

In step S48, when the user determines a menu item, a determination message is issued.

In step S49, the OS 2 conducts a hook FB-3 and notifies the determination message of the suppressed application 3.

In step S50, the suppressed application 3 determines the menu item based on the determination message. In step S51, the suppressed application 3 executes a process corresponding to the menu item determined in the step S50.

As described above, the OS 2 conducts the hooks FB-1, FB-2, and FB-3 at the menu initialization, the menu selection, and the menu item determination, respectively, and then notifies of the suppressed application 3. Then, the suppressed application 3 executes various processes for the menu display, the menu selection, the menu item determination and each menu item. The tool 1 according to the embodiment of the present invention can realize to conduct the suppress process (step S30 in FIG. 5) based on the definition file 4 in response to a notice from the OS 2 when the hooks FB-1, FB-2, and FB-3 are conducted, respectively, and to notify the menu, for which the suppress process is conducted, of the suppressed application 3.

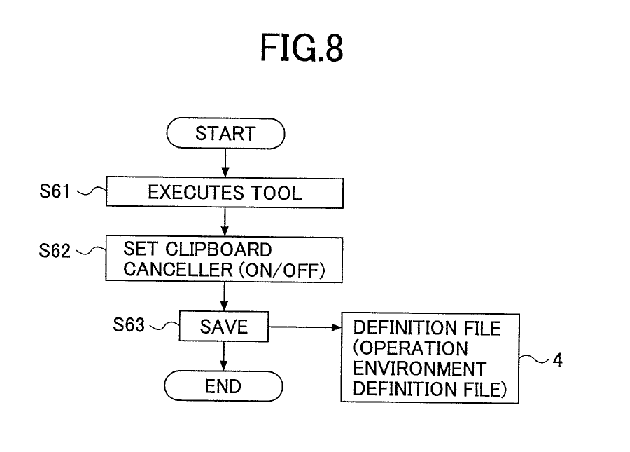

FIG. 8 is a flowchart diagram for explaining a setting for suppressing a copy operation by the user, according to the embodiment of the present invention.

In step S61 in FIG. 8, the system manager executes the tool 1.

In step S62, the system manager sets a clipboard canceller to suppress or allow the copy operation by the user. That is, the system manager sets “ON” to the clipboard canceller in order to suppress copying of data through a clipboard, or sets “OFF” to the clipboard canceller in order to allow to copy data through the clipboard.

In step S63, the system manager saves a setting of the clipboard canceller to the definition file (the operation environment definition file) 4.

As described above, it is possible to prohibit copying of data through the clipboard.

FIG. 9 is a flowchart diagram for explaining an operation for suppressing copying of data according to the embodiment of the present invention.

In step S71 in FIG. 9, the user conducts a copy operation for copying data on the display unit of the user terminal.

In step S72, in response to the copy operation by the user, the OS 2 transfers data at a copy-from to the clipboard.

In step S73, the OS 2 conducts the hook FB and notifies the copy operation by the user of the tool 1.

In step S74, the tool 1 detects that data at the copy-from is transferred to the clipboard and the tool 1 executes the copy suppress processing part 53.

In step S75, the copy suppress processing part 53 determines whether or not to suppress copying of data. That is, when the data is transferred to the clipboard in the step S74, the copy suppress processing part 53 refers to the definition file 4 to determine whether or not the clipboard canceller is set to “ON”.

In step S76, the copy suppress processing part 53 checks whether or not a determination result in the step S75 shows to suppress copying of data. That is, when the determination result based on the setting of the clipboard canceller in the step S75 shows “ON” (YES), the copy suppress processing part 53 advances to step S77. On the other hand, when the determination result based on the setting of the clipboard canceller in the step S75 shows “OFF” (NO), the copy suppress processing part 53 terminates the operation for suppressing copying of data.

In step S77, since the setting of the clipboard canceller in the definition file 4 is “ON” (YES in the step S76), the copy suppress processing part 53 clears data transferred into the clipboard.

In step S78, the user conducts a paste instruction for pasting the data copied in the step S71.

In step S79, in response to the paste instruction by the user, the application 3 replaces the data with empty data in the clipboard at a location where the user pastes the data. That is, when the data transferred into the clipboard is cleared in the step S77 (the clipboard canceller in the definition file 4 is set to “ON”), the cleared data is copied to a copy-to. As a result, the original data at the copy-from cannot be copied (can be prohibited or suppressed). On the other hand, when the clipboard canceller in the definition file 4 is set to “OFF”, the original data at the copy-from is copied to the copy-to since the data transferred from the copy-from to the clipboard is not cleared (a normal copy operation via the clipboard is conducted).

As described above, by simply setting “ON” for the clipboard canceller in the definition file 4, it is possible to prohibit (suppress) copying of data through the clipboard.

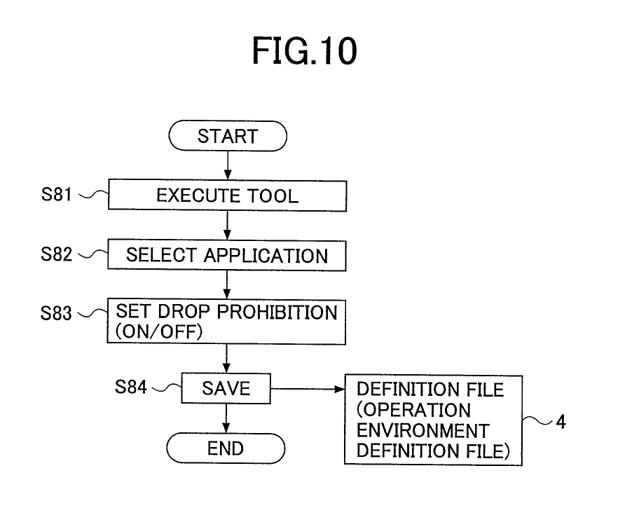

FIG. 10 is a flowchart diagram for explaining a setting for suppressing a move operation by the user, according to the embodiment of the present invention.

In step S81 in FIG. 10, the system manager executes the tool 1.

In step S82, the system manager selects one application in that the move operation is prohibited.

In step S83, the system manager sets a drop prohibition to suppress or allow the move operation by the user. That is, when the system manager sets “ON” to the drop prohibition, it is prohibited to move data by a drop operation by using a mouse.

In step S84, the system manager saves a setting of the drop prohibition to the definition file (the operation environment definition file) 4.

As described above, it is possible for the system manager to set the drop operation so as to prohibit moving of data by the drop operation by using mouse.

FIG. 11 is a flowchart diagram for explaining an operation for suppressing moving of data according to the embodiment of the present invention.

In step S91 in FIG. 11, the user presses the mouse (left button) at a location (move-from) of data that the user wants to move. In step S92, in response to this mouse click by the user, the OS 2 conducts the hook (FM) to notify of the tool 1.

In step S93, the tool 1 executes the move suppress processing part 54 and then the move suppress processing part 54 stores the location (move-from) where the user pressed the mouse in the step S91.

In step S94, the application 3 is activated.

In step S95, the user drags the mouse to move data to another location (move-to) while the user presses the mouse (left button).

In step S96, in response to this move operation, the data moves on the application 3.

In step S97, the user releases the mouse (left button).

In step S98, the OS 2 conducts a process for a case in which the user releases the mouse (left button) up.

In step S99, the move suppress processing part 54 searches for the location (move-to) where the user releases the mouse (left button).

In step S100, the move suppress processing part 54 searches for the application 3 on the location (move-to) where the user releases the mouse (left button).

In step S101, the tool 1 determines whether or not the application 3 is to be suppressed. That is, the move suppress processing part 54 refers to the definition file 4 and determines whether or not the application 3 is the application selected and registered by the system manager in the step S82 in FIG. 10. When the move suppress processing part 54 determines that the application 3 is registered (YES), the move suppress processing part 54 advances to step S102. On the other hand, when the move suppress processing part 54 determines that the application is not registered (NO), the move suppress processing part 54 terminates the operation for suppressing moving of data.

In step S102, the move suppress processing part 54 moves a current mouse location to the location (move-from) that is stored in the step S93, since the application 3 is registered in the definition file 4 to suppress moving of data in the step S101 (YES).

In step S103, the move suppress processing part 54 releases the mouse (left button). That is, software releases the mouse at the location (move-from).

In step S104, the application 4 conducts a copy process for copying data from the move-from to the move-to. That is, in a case in which the drop prohibition for the application 3 on the location where the user releases the mouse is set to “ON” in the definition file 4, the move suppress processing part 54 of the tool 1 compulsory moves the current mouse location to the move-from that is the location stored in the step S93 and releases the mouse (left button) (the steps S101 (YES), S102, and S103). As a result, the application 3 ends up copying the data from the move-from to the move-from. Therefore, it is possible to suppress (prohibit) moving of data. On the other hand, in a case in which the move suppress processing part determines that the application 3 is not required to suppress moving of data in step S101 (NO), the application 3 normally copies the data from the move-from where the user presses the mouse at the move-to where the user releases the mouse.

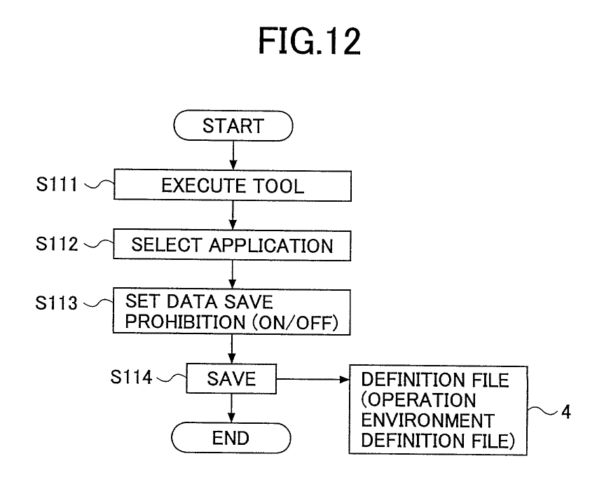

FIG. 12 is a flowchart diagram for explaining a setting for suppressing a save operation by the user, according to the embodiment of the present invention.

In step S111 in FIG. 12, the system manager executes the tool 1.

In step S112, the system manager selects one application in that the save operation is prohibited.

In step S113, the system manager sets a data save prohibition to suppress or allow the save operation by the user. That is, when the system manager sets “ON” to the data save prohibition, it is prohibited for the user to save data by selecting an item in a dialog box.

In step S114, the system manager saves a setting of the data save prohibition to the definition file (the operation environment definition file) 4.

As described above, it is possible for the system manager to set the data save prohibition so as to prohibit saving of data by selecting an item in the dialog box.

FIG. 13 is a flowchart diagram for explaining an operation for suppressing saving of data according to the embodiment of the present invention.

In step S121 in FIG. 13, the user conducts the save operation at the display unit of the user terminal.

In step S122, in response to the save operation by the user, the application 3 conducts a saving process for saving data.

In step S123, the application 3 processes to display a save dialog box for the user to save data.

In step S124, the OS 2 conducts the hook FB and notifies of the tool 1.

In step S125, the tool 1 executes the save suppress processing part 55 and the save suppress processing part 55 determines whether or not the application 3 is to be suppressed. That is, the save suppress processing part 55 refers to the definition file 4 and determines whether or not the application 3 is the application selected and registered by the system manager. When the save suppress processing part 55 determines that the application 3 is registered (YES), the save suppress processing part 55 advances to step S126. On the other hand, when the save suppress processing part 55 determines that the application is not registered (NO), the save suppress processing part 55 terminates the operation for suppressing saving of data.

In step S126, the save suppress processing part 55 determines whether or not a dialog box notified by the hook FB is the save dialog box, since it is determined in the step S125 (YES) that the application 3 is to be suppressed in a case in which data is saved by the user.

In step S127, the save suppress processing part 55 checks whether or not a determination result in the step S126 indicates the save dialog box. When the determination result indicates the save dialog (YES), the save suppress processing part 55 advances to step S128. On the other hand, when the determination result does not indicate the save dialog box (NO), the save suppress processing part 55 terminates the operation for suppressing saving of data.

In step S128, the save suppress processing part 55 searches for a save button showing “SAVE”, “OK” or “YES” in the save dialog box.

In step S129, the save suppress processing part 55 determines whether or not the save button is found. When the save button is found (YES), the save suppress processing part 55 advances to step S130. On the other hand, when the save button is not found (YES), the save suppress processing part 55 terminates the operation for suppressing saving of data.

In step S130, the save suppress processing part 55 changes a button style of the save dialog box not to display the save button (invisible) and also sets the button style to disable to save the data.

In step S131, the save dialog box is displayed at the display unit of the user terminal. In a case in which the button style of the save dialog box is changed not to display the save button (invisible) and also to disable to save the data, the user cannot save the data even if the user clicks the save dialog box.

As described above, when the user conducts the save operation, the button style of the save dialog box is changed not to display the save button (invisible) and also to disable to save the data in the case in which the tool 1 notified by the hook FB determines that the application 3 is registered in the definition file 4 and also the saving dialog is notified by the hook FB. Therefore, it is possible to prohibit (suppress) saving of data.

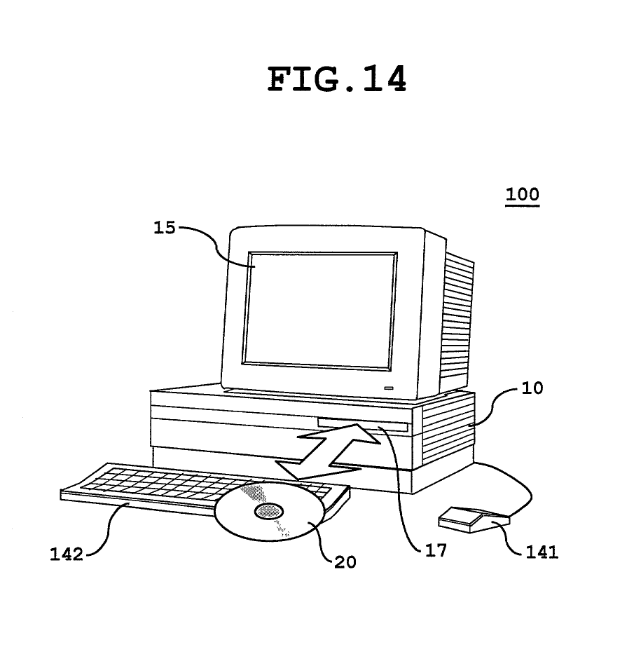

FIG. 14 is a front view of the computer system according to the embodiment of the present invention. In FIG. 14, the computer system 100 as the user terminal includes a main unit 10 for controlling the computer system 100, a mouse 141 and a keyboard 142 for inputting data, a display unit 15 and a CD-ROM driver 17.

The main unit 10 connects to and controls the mouse 141, the keyboard 142, the display unit 15, and the CD-ROM driver 17, in order to realize the operations described above. The mouse 141 and a keyboard 142 are used to input data. The display unit 15 displays, for example, the window 170 for setting menu item details in FIG. 2 for the system manager. The CD-ROM driver 17 is used to install various programs related to the tool 1 from a CD-ROM 20.

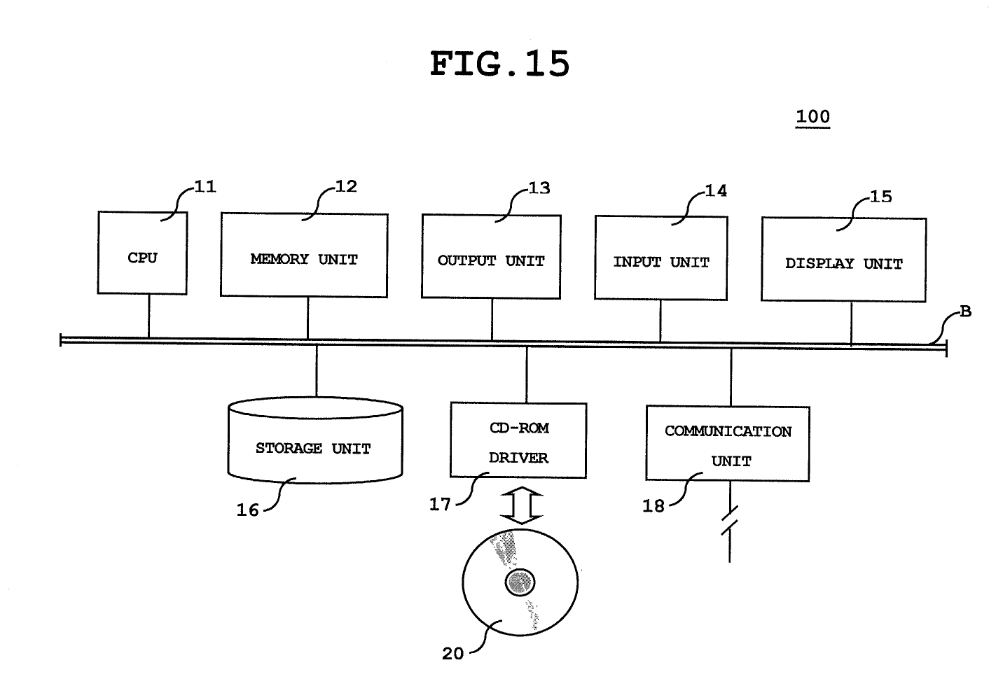

FIG. 15 is a diagram showing a hardware configuration of the computer system according to the embodiment of the present invention. In FIG. 15, the computer system 100 includes a CPU (Central Processing Unit) 11, a memory unit 12, an output unit 13, an input unit 14, the display unit 15, a storage unit 16, the CD-ROM driver 17, and a communication unit 18, all of which are connected together through a bus B. The CPU 11, the memory unit 12, the storage unit 16, the CD-ROM driver 17, and the communication unit 18 are mounted in the main unit 10 shown in FIG. 14.

The CPU 11 controls the computer system 100 in accordance with programs stored in the memory unit 12 and also executes processes realizing the operation described above. The memory unit 12 includes a RAM and a ROM and stores the programs executed by the CPU 11, data necessary for the processes, and data obtained by the processes. Also, the memory unit 12 is partially used as a working area for the processes executed by the CPU 11.

The output unit 13 includes a printer or the like and is used to output a process result or indicated information. The input unit 14 includes the mouse 141, the keyboard 142, or the like and is used to input information. The display unit 15 displays information for the system manager and the user.

The storage unit 16 includes a hard disk and stores files, databases and programs of the applications 3, tool 1 and a like. The communication unit 18 controls data transmissions for sending or receiving information.

For example, the programs related to the tool 1 are installed into the computer system 100 by loading the CD-ROM 20 into the CD-ROM driver 17. That is, when the CD-ROM 20 storing the programs is inserted in the CD-ROM driver 17, the CD-ROM driver 17 reads the program from the CD-ROM 20 and the programs read from the CD-ROM 20 are installed into the storage unit 16 via the bus B. When the process is executed, the CPU 11 executes the process in accordance with the program installed into the storage unit 16. It should be noted that a recording medium is not limited to the CD-ROM 20, but another computer-readable recording medium such as a magnetic disk, a magnetic tape, an optical disk, a magneto-optical disk, a semiconductor memory or the like may be used.

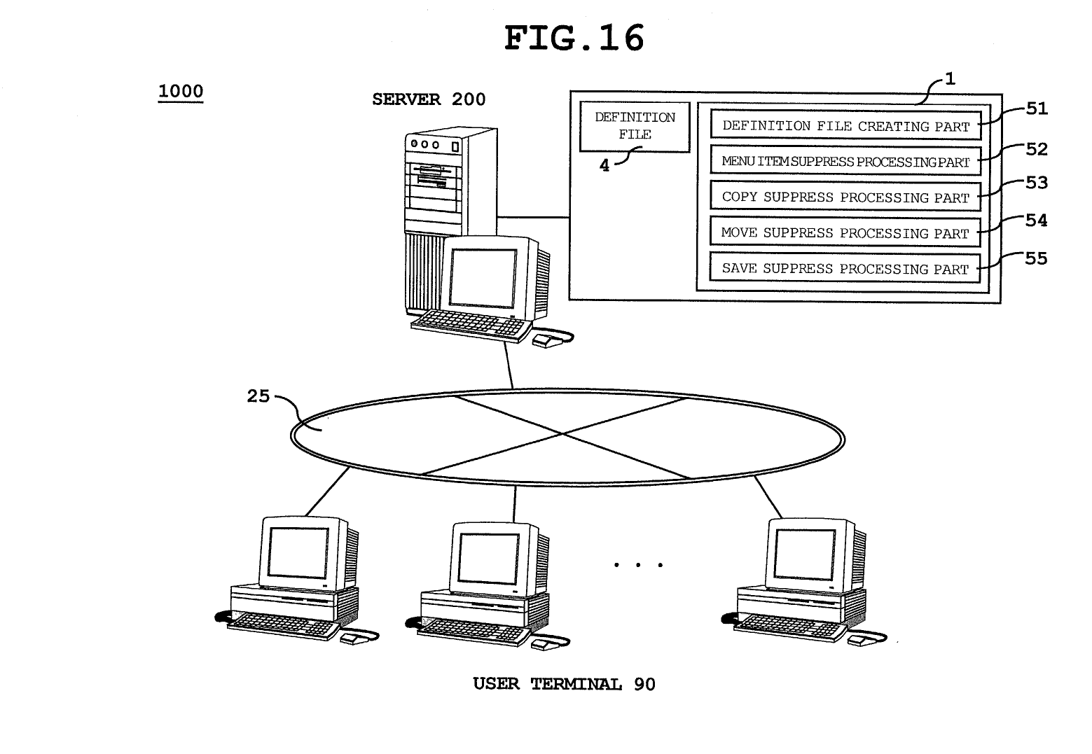

The tool 1 including the definition file 4, the definition file creating pat 51, the menu item suppress processing part 52, the copy suppress processing part 53, the move suppress processing part 54, and the save suppress processing part 55 can be provided to a server 200 in a network system 1000 as shown in FIG. 16.

FIG. 16 is a diagram showing the network system in which the tool 1 is installed, according to the present invention. In FIG. 16, the network system 1000 includes the server 200 and a plurality of user terminals 90, all of which are connected each other through a network 25. The tool 1 installed into the server 200 can realize to suppress the menu and control copying of data and moving of data as described above. Thus, parts and a file that are the same as the ones in FIG. 1 are indicated by the same reference numerals and a detailed explanation thereof will be omitted.

By installing tool 1 from the server 200 to each user terminal 90 through the network 25, it is also possible to suppress the menu and control copying of data and a moving of data at each user terminal 90. That is, the system manager accesses the server 200 to install the tool 1 into each user terminal 90. Accordingly, each user terminal 90 becomes functionally equal to the computer system 100 shown in FIG. 1. It should be noted that each user terminal 90 is similarly configured as shown in FIG. 14 and a hardware configuration of each user terminal 90 is also similar to the hardware configuration as shown in FIG. 16.

At each user terminal 90, the system manager sets up the menu item details on the menu provided in the application 30, sets the clipboard canceller to “ON” and the drop prohibition to “ON”, and sets the data save prohibition to “ON”. Then, all settings by the system manager are registered in the definition file 4 in each user terminal.

Therefore, it can be realized to prevent the incorrect operation by the user, the information leak, the falsification, and the system destruction, instead of modifying the application 3 or the OS 2.

As described above, according to the present invention, in response to an operation of user, the OS 2 conducts the hook function and then the tool 1 retrieves the application ID corresponding to a menu item of the application 3, refers to the definition file, and processes to suppress a function corresponding to the menu item. Therefore, it can be realized that an error operation by the user, the information leak, the falsification, or the system destruction is protected, instead of modifying the application 3 or the OS 2.

In addition, the tool 1 clears the content in the clipboard when the user copies data on the application 3, the tool 1 compulsory changes the move-to to the move-from when the user moves data from the move-from to the move-to, or the tool 1 makes the save button to become invisible in the save dialog box and also disables the save dialog box to save data. Therefore, it can be realized to prohibit the user copying data without notice, moving data, and saving data, instead of modifying the application 3 or the OS 2.

The present invention is not limited to the specifically disclosed embodiments, variations and modifications, and other variations and modifications may be made without departing from the scope of the present invention.

The present application is based on Japanese Priority Application No.2000-262971 filed on Aug. 31, 2000, the entire contents of which are hereby incorporated by reference.

What is claimed is:

1. A method for suppressing menu items on a menu, comprising the steps of:
(a) retrieving said menu items for said menu when an operating system conducts a hook function to notify that an application displays said menu;
(b) conducting a suppress process indicated in a definition file for each of said menu items when said menu items retrieved in said step (a) have been registered in said definition file; and
(c) passing said menu having said menu items to said application when said suppress process is conducted in said step (b),
whereby said menu is displayed with said menu items for each of which said suppress process is conducted.

2. A method for suppressing menu items on a menu, comprising the step of:
(a) retrieving said menu items for said menu and an application ID specifying an application of said menu items when an operating system conducts a hook function to notify that said application displays said menu;
(b) conducting a suppress process indicated in a definition file for a location of said application ID retrieved in said step (a) for said menu items when said menu items retrieved in said step (a) have been registered in said definition file; and
(c) passing said menu having said menu items to said application when said suppress process is conducted in said step (b),
whereby said menu is displayed with said menu items for each of which said suppress process is conducted.

3. A method for controlling a dialog box, comprising the steps of:
(a) detecting a notice for displaying said dialog box and dialog items when an operating system conducts a hook function to notify that an application displays said dialog box;
(b) conducting a suppress process indicated in a definition file for said dialog box when said notice for displaying said dialog box detected in said step (a) has been registered; and
(c) passing said menu having said menu items to said application when said suppress process is conducted in said step (b),
whereby said dialog box is displayed in which said suppress process is conducted for said dialog items.

4. The method as claimed in claim 1, wherein said suppress process conducts at least one of a first suppress display for suppressing an operation corresponding to each of said menu items and displaying said menu items in luminosity or a color that is different from a normal display, a second suppress display for suppressing said operation corresponding to each of said menu items and making said menu items invisible, and a third suppress display for suppressing said operation corresponding to each of said menu items.

5. A method for controlling copying of data, comprising the steps of:
(a) detecting a notice for copying data when an operating system conducts a hook function to notify that a copy operation is conducted on an application;
(b) clearing a content of a clipboard when said notice for copying data is detected in said step (a) has been registered in a definition file and a copy suppress is indicated in said definition file; and
(c) passing said clipboard to said application when said content of said clipboard is cleared in said step (b),
whereby said application copies said content of said clipboard which is empty.

6. A method for controlling moving of data, comprising the steps of:
(a) detecting a notice for moving data when an operating system conducts a hook function to notify that a move operation indicating a move-to location and a move-from location is conducted on an application;
(b) changing said move-to location to said move-from location when said notice for moving data is detected in said step (a) has been registered in a definition file and a move suppress is indicated in said definition file; and
(c) passing said move-to location to said application when said move-to location is changed in said step (b),
whereby said application moves said data from said move-from location to said move-to location which is said move-to location.

7. A method for controlling moving of data, comprising the steps of:
(a) detecting a notice for moving data when an operating system conducts a hook function to notify that a move-to operation is conducted on an application;
(b) changing said move-to location to said move-from location when said notice for moving data is detected in said step (a) has bee n registered in a definition file and a move suppress is indicated in said definition file; and
(c) passing said move-to location to said application when said move-to location is changed in said step (b),
whereby said application moves said data from said move-from location to said move-to location which is said move-to location.

8. A computer-readable recording medium recorded with program code for causing a computer to suppress menu items on a menu, said program comprising the codes for:
(a) retrieving said menu items for said menu when an operating system conducts a hook function to notify that an application displays said menu;
(b) conducting a suppress process indicated in a definition file for each of said menu items when said menu items retrieved in said code (a) have been registered in said definition file; and
(c) passing said menu having said menu items to said application when said suppress process is conducted in said code (b),
whereby said menu is displayed with said menu items for each of which said suppress process is conducted.

9. A computer-readable recording medium recorded with program code for causing a computer to suppress menu items on a menu, said program comprising the codes for:
(a) retrieving said menu items for said menu and an application ID specifying an application of said menu items when an operating system conducts a hook function to notify that said application displays said menu;
(b) conducting a suppress process indicated in a definition file for a location of said application ID retrieved in said code (a) for said menu items when said menu items retrieved in said code (a) have been registered in said definition file; and
(c) passing said menu having said menu items to said application when said suppress process is conducted in said code (b),
whereby said menu is displayed with said menu items for each of which said suppress process is conducted.

10. A computer-readable recording medium recorded with program code for causing a computer to control a dialog box, said program comprising the codes for:
A method for controlling a dialog box, comprising the codes of:
(a) detecting a notice for displaying said dialog box and dialog items when an operating system conducts a hook function to notify that an application displays said dialog box;
(b) conducting a suppress process indicated in a definition file for said dialog box when said notice for displaying said dialog box detected in said code (a) has been registered; and
(c) passing said menu having said menu items to said application when said suppress process is conducted in said code (b),
whereby said dialog box is displayed in which said suppress process is conducted for said dialog items.

11. A computer-readable recording medium recorded with program code for causing a computer to control copying of data, said program comprising the codes for:
(a) detecting a notice for copying data when an operating system conducts a hook function to notify that a copy operation is conducted on an application;
(b) clearing a content of a clipboard when said notice for copying data is detected in said code (a) has been registered in a definition file and a copy suppress is indicated in said definition file; and
(c) passing said clipboard to said application when said content of said clipboard is cleared in said code (b),
whereby said application copies said content of said clipboard which is empty.

12. A computer-readable recording medium recorded with program code for causing a computer to control moving of data, said program comprising the codes for:
(a) detecting a notice for moving data when an operating system conducts a hook function to notify that a move operation indicating a move-to location and a move-from location is conducted on an application;
(b) changing said move-to location to said move-from location when said notice for moving data is detected in said code (a) has been registered in a definition file and a move suppress is indicated in said definition file; and
(c) passing said move-to location to said application when said move-to location is changed in said code (b),
whereby said application moves said data from said move-from location to said move-to location which is said move-to location.

13. A computer-readable recording medium recorded with program code for causing a computer to control moving of data, said program comprising the codes for:
(a) detecting a notice for moving data when an operating system conducts a hook function to notify that a move-to operation is conducted on an application;
(b) changing said move-to location to said move-from location when said notice for moving data is detected in said code (a) has been registered in a definition file and a move suppress is indicated in said definition file; and
(c) passing said move-to location to said application when said move-to location is changed in said code (b),
whereby said application moves said data from said move-from location to said move-to location which is said move-to location.

14. An apparatus for suppressing menu items, comprising:
a retrieving part retrieving said menu items for said menu when an operating system conducts a hook function to notify that an application displays said menu;
a conducting part conducting a suppress process indicated in a definition file for each of said menu items when said menu items retrieved in said retrieving part have been registered in said definition file; and
a passing part passing said menu having said menu items to said application when said suppress process is conducted in said conducting part,
whereby said menu is displayed with said menu items for each of which said suppress process is conducted.
